(19) United States
(12) Patent Application Publication
(10) Pub. No.: US 2008/0196965 A1
(43) Pub. Date: Aug. 21, 2008

(54) Transmission Drive Unit With a Support Tube, and Method for Manufacturing Such a Transmission Drive Unit

(76) Inventors: Hans-Juergen Oberle, Rastatt (DE); Andreas Lienig, Buehl (DE)

Correspondence Address: MICHAEL J. STRIKER, 103 EAST NECK ROAD, HUNTINGTON, NY, 11743, US

(21) Appl. No.: 11/994,591

(22) PCT Filed: Jun. 28, 2006
(86) PCT No.: PCT/EP2006/063617

§ 371 Date: Jan. 3, 2008

(30) Foreign Application Priority Data
Sep. 28, 2005 (DE) 102005046357.6

(51) Int. Cl. B60K 17/00

(52) U.S. Cl. 180/384

(57) ABSTRACT

The invention relates to a transmission drive unit (10), especially for adjusting a mobile part in the motor vehicle. Said drive unit comprises a drive assembly (42) driving, by means of a drive element (40), a drive wheel (18) received on a spindle. The drive wheel (18) is rotatably received in a support tube (14) having a seat (52) for a securing device (54) for diverting crash forces. At least one circular or annular support element (62) can be secured between an axial end (60) of the support tube (14) and the seat (52) in order to mechanically reinforce the support tube (14). Said support element can be retrofitted and separately installed.

### RELATED ART

The present invention relates to a transmission drive unit with a support tube, in particular for adjusting a movable part in a motor vehicle, and a method for manufacturing such a transmission drive unit, according to the preamble of the independent claims.

Publication EP 0 759 374 A2 made known a device for adjusting a seat in a motor vehicle, which may absorb considerably greater forces than during normal operation. Forces such as these may be caused, e.g., by a traffic accident. It is important that the vehicle seat remain fixedly connected with the body, to ensure that the protective measures (seat belt, air bag) provided for the vehicle occupants may function. With the device described above, a counternut that accommodates a threaded spindle is fixedly connected with the body. The threaded spindle is driven via a worm gear pair by an electric motor, which is fixedly connected with the seat. The transmission housing of the worm gear pair is made of plastic and is connected with the drive motor via a further housing part. When the drive motor is actuated, the threaded spindle rotates and displaces the transmission housing, including the drive motor and seat, relative to the counternut. To prevent the transmission housing from tearing loose from the threaded spindle, e.g., when an accident occurs, an additional, metallic, U-shaped support part is provided, which connects the transmission housing via a hinged fastening bolt with the drive motor and, therefore, the seat. If the plastic transmission housing is unable to withstand the strong flow of force, it is held by the metallic support part using an additional counternut. The disadvantage of this design is that a complex support structure is required in addition to the entire transmission housing, which increases the number of components and requires additional installation space.

Publication EP 1 223 073 A2 makes known a spindle drive, with which additional support elements are installed in the transmission housing to absorb crash forces. In a further exemplary embodiment, a support disk is located inside an injection-molded worm wheel to prevent the spindle from tearing out of the transmission housing. The disadvantage of this embodiment is that the entire transmission housing and/or the worm wheel must be redesigned for different crash requirements. For very strong loads, e.g., an additional support collar is located around the transmission housing. These design changes are associated with high tool costs, so adapting the spindle drive to different crash requirements is also associated with high costs.

### ADVANTAGES OF THE INVENTION

The inventive transmission drive unit and its inventive manufacturing method with the features of the independent claims have the advantage that, by locating the drive wheel of the spindle in a support tube, a separate standardized assembly is created that is independent of the drive assembly. By eliminating a conventional transmission housing, with which the driven element of the drive assembly and the drive wheel of the spindle are both located in a closed housing, the transmission drive unit, as a modular system, may be adapted—very flexibly—to different strength requirements. The same drive assembly may always be used, since the mechanical interface for transferring the drive torque also remains the same for different crash requirements. Since all of the crash forces are absorbed by the support tube and are diverted to the fastening device, only the support tube is adapted to the different strength requirements. By using a standardized support tube, with which different support elements may be integrally formed, a very high level of flexibility of the spindle drive is attained, in a very cost-effective manner. Advantageously, the cylindrical support elements may be subsequently attached in the support tube, fully independently of the installation of the spindle and its drive wheel in the support tube. Tests have shown that, when a crash occurs, the highest loads on the support tube occur between the receptacle for the fastening device and the corresponding axial end of the support tube. The crash resistance may therefore be increased in a particulary effective manner by reinforcing the support tube using the support element at least in the region between the receptacle and the axial end of the support tube located closest to the receptacle. The introduction of force is advantageously distributed evenly around the entire circumference of the support tube.

Advantageous refinements and improvements of the features indicated in the independent claims are made possible by the measures listed in the subclaims. When the support element includes, e.g., a circular recess, the support element may be attached very easily on the outer circumference of a round support tube, in order to stabilize it. With this design of the support element as an outer ring, it may also be installed before the spindle is installed on the support tube. This design is also suited, in particular, for a plunger spindle, in the case of which the spindle extends out of the support tube at both axial ends.

In an alternative embodiment, the support element is attached inside the support tube, to the inner wall surface, in order to reinforce it. The support element may be designed as an inner ring or a complete disk. A support disk stabilizes the support tube to an even greater extent. These diverse support elements may be connected very easily with the standard support tube in accordance with the particular strength requirements. A further advantage of the inwardly located support element is that no additional work is created, i.e., the support element is located inside the installation space that is required anyway, and it does not create any additional, disturbing edges.

The support element with a thread may be screwed into or onto the support tube particularly easily. To this end, the support tube includes—on its outer circumferential surface and/or its inner wall, at least in the region between the receptacle and the axial end located closer thereto—a thread, which engages in a corresponding thread of the support element. As an alternative, the support element includes a self-tapping or self-cutting thread that forms a counter-thread in the support tube when installed in the support tube.

In an alternative embodiment, the support element may also be bonded or welded to the support tube, or it may be caulked with the support tube via cold deformation. With these connection methods, the support tube and the support elements may also have a non-circular cross section.

Due to the modular design of the support tube, the standard support tube may be made of an easily formed deep-drawn metal, and the support rings used to provide strong crash resistance may be made of a stronger material, e.g., hardened steel.

A fastening bolt is a widely used customer interface for connecting the spindle drive to the motor vehicle; it may be rotatably supported in a hole-shaped receptacle in the support tube. The crash forces that act on a seat, for instance, are transferred to the support tube via the fastening bolt in the receptacle. By designing the fastening device as a pivot bolt, the spindle is hingedly supported between the part to be adjusted and the body, thereby resulting in a greater degree of freedom of the adjusting motion.

It is particularly favorable when the support element is inserted axially on or in the support tube until it bears axially against the fastening bolt, at least when an external force is applied. As a result, the forces are transferred directly from the fastening bolt to the support element, thereby enabling the spindle—with its drive wheel—to be held in the support tube.

The spindle can be supported very favorably in the support tube by providing axial projections on the drive wheel, which is supported on the spindle. The axial projections are accommodated in a pot-shaped bearing receptacle of the support tube and/or an end plate fastened therein. The pot-shaped bearing receptacles may simultaneously support the spindle radially and axially. When the at least one end plate is made of plastic, it may interact, e.g., with a spherical, metallic axial stop of the spindle with minimal friction.

In a preferred embodiment, the spindle with the receptacle for the fastening device, which is supported in the support tube, is a first preassembled assembly, which may be coupled very easily via a coupling device with a standardized drive assembly, e.g., an electric motor with an armature worm. To transfer force to the drive element of the spindle, the driven element of the drive assembly extends through an opening in the support tube. Since the recess in the support tube is relatively small, the support tube may absorb high forces without the spindle being torn out of the support tube. This inventive transmission drive unit therefore does not include a classical transmission housing that encloses the driven wheel of the drive and the drive wheel of the transmission, but rather includes a largely closed support tube, with the driven element being fixed in place relative thereto using the coupling device. To attach the coupling device, further recesses are formed in the support tube, for example, into which a fastening means of the coupling device engages for fixation. The drive assembly with its driven element is located completely outside of the flow of forces that occurs during a crash.

When the support element is loaded in the axial direction relative to the fastening device, the support element may dig directly into the support tube in order to fix itself in position. This results in the elimination of an additional fastening process of the support element, such as bonding, welding, or material deformation. Given that the support element bears against the fastening element with preload, the force of the fastening element may be transferred to the support element and, therefore, to the support tube with no axial play.

It is advantageous to manufacture the support element as a circular clamping disk that has an edge around its entire circumference that clamps tightly in the wall of the support tube. If the edge is designed with a sharp edge, it may dig into the tube wall in such a manner that it may not be displaced. With this embodiment, the step of forming a thread on the support element and/or the support tube is eliminated.

To attain an axial preload relative to the fastening device, the plate-shaped clamping disk is shaped axially away from the fastening device in its outer radial region. As a result, the outer edge may more easily engage in the material of the support tube when the clamping disk is installed, the central region of the clamping disk being pressed against the fastening device. A support element of this type may be manufactured very cost-favorably as a bent blank.

For higher strength requirements, several clamping disks—depending on the need—may be fixed in position in the support tube such that they bear axially against each other. As a result, all of the installed clamping disks are involved in the transfer of force to the support tube around their circumference. Since the clamping disks are plate-shaped, they may be stacked on top of each other in a form-fit manner, so that they bear flat against each other and stabilize each other against deformation.

In addition, a force-transmission disk may be inserted between the at least one support element and the fastening device, the force-transmission disk having, e.g., a greater resistance to deformation than the support elements. As a result, the force of the, e.g., bolt-shaped fastening device may be transferred to a larger circular surface and forwarded to the support elements. As a result, the axially acting force is transferred to a large surface and, therefore, evenly to the entire circumference of the support elements.

The inventive manufacturing method according to independent claim 16 has the advantage that the assembly with the support tube is installed separately from the drive assembly. As a result, after the fastening means are installed on the support tube, they may be easily adapted to the particular strength requirement using the support elements. A modular system of this type, with which different drive assemblies may also be used, is very cost-favorable and customer-friendly.

The support elements may be very easily varied in terms of shape and material without having to change the design and assembly process of the transmission drive unit.

Via the inventive process for installing the support elements, which are designed as clamping disks, the clamping disks are fixed securely in position in the support tube in one process step, simultaneously with the insertion of the clamping disks. The clamping disks are pressed axially against the fastening device with a specifiable contact pressure, which causes the clamping disks to dig into the wall surface of the support tube with axial preload. Depending on the strength requirement, one or more clamping disks may be installed in one working step.

### DRAWING

Various exemplary embodiments of an inventive transmission drive unit are presented in the drawing, and they are described in greater detail in the description below.

FIG. 1 shows a cross section through an inventive transmission drive unit,

FIG. 2 shows a side view of an assembly with the support tube, which may be installed separately,

FIG. 3 shows a cross section of the assembly in FIG. 2, and

FIG. 4 shows a further embodiment according to FIG. 2, in a cross-sectional view.

### DESCRIPTION

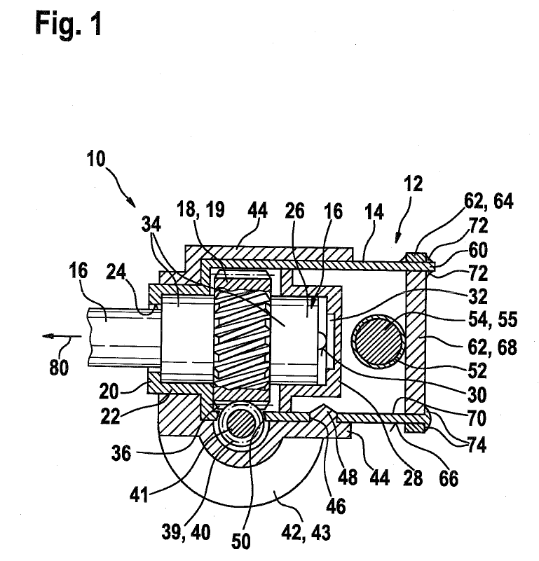

Transmission drive unit 10 shown in FIG. 1 is composed of a first assembly 12, with which a spindle 16 with a drive element 18 located thereon is supported in a support tube 14. Support tube 14 is manufactured, e.g., using deep drawing, and includes a pot-shaped bearing receptacle 22 for drive wheel 18 on an end region 20. Spindle 16 extends out of support tube 14 through opening 24 in pot-shaped bearing receptacle 22 and is connected with the body, e.g., via a counternut, which is not shown. With this exemplary embodiment, the other spindle end 26 is located inside support tube 14 and is supported axially and radially via an end shield 28 that is attached inside support tube 14. Spindle end 26 includes, e.g., a spherical stop surface 30, which rests axially against pot-shaped end shield 28. Optionally, a stiffer thrust washer 32 may be located in end shield 28. In this exemplary embodiment, drive wheel 18 is designed as worm wheel 19, which includes axial projections 34 for radial support. Drive wheel 18 is injection-molded, e.g., using plastic, directly onto spindle 16 and includes toothing 36 that meshes with a driven element 40 of a drive assembly 42. Drive assembly 42 is designed as an electric motor 43 and is connected with first assembly 12 using a coupling device 44. Support tube 14 has a projection 46, which is used to position support tube 14 relative to coupling device 44, and into which a fixing element 48 of coupling device 44 engages. To transfer the torque from drive assembly 42 to separate assembly 12, support tube 14 has a radial recess 50 into which driven element 40 engages. Driven element 40 is designed, e.g., as worm 39, which is located on an armature shaft 41 of electric motor 43. Support tube 14, which serves as a housing for separate assembly 12, also includes a receptacle 52 into which a fastening device 54, e.g., a pivot bolt 55, may be slid. With this fastening device 54, support tube 14 is hingedly connected with an adjusting part 58 in the motor vehicle, e.g., a not-shown seat or a seat part that is adjusted relative to another seat part.

Support elements 62 are attached to support tube 14 between receptacle 52 and an end 60 of support tube 14 located closer thereto. A first support element 62 is designed as outer ring 64, which rests in an outer circumferential surface 66 of support tube 14. Inside support tube 14, a further support element 62 is designed as circular disk 68, which bears against inner wall 70 of support tube 14. In the top half of the drawing, support elements 62 are connected with support tube 14, e.g., via welds 72. The lower half of the drawing shows an attachment of support element 62 using caulking 74 via plastic material deformation.

If a compression force 80 acts on spindle 16 when an accident occurs in axial direction 76, spindle 16 is supported via drive wheel 18 in pot-shaped bearing receptacle 22 of support tube 14. Compression force 80 is transferred via support tube 14 to fastening device 54, thereby resulting in a high material load between receptacle 52 and end 60 of support tube 14. These strong forces are absorbed by one or more support elements 62, which therefore increase the absorption of force by support tube 14 without it being destroyed. As a result, spindle end 26 and, therefore, part 58 to be adjusted, remain in their intended places when a crash occurs.

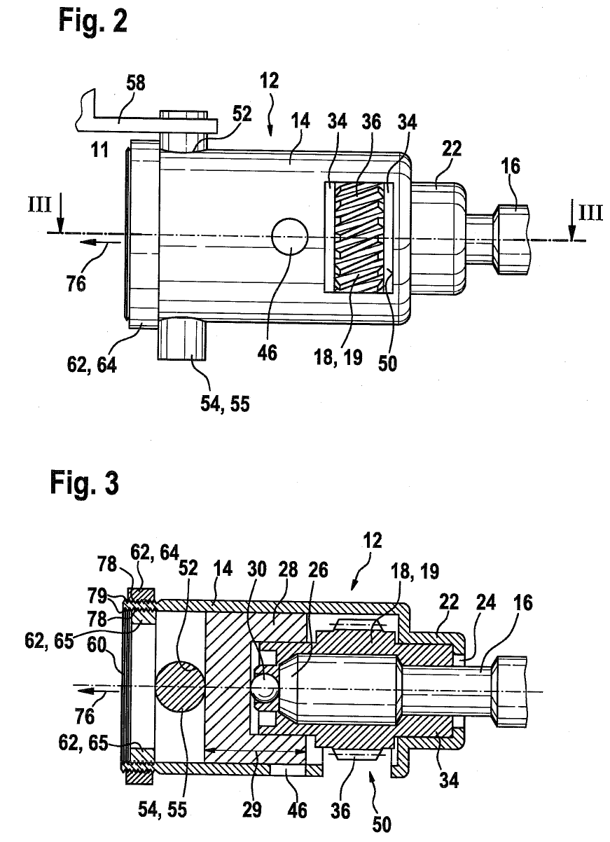

FIG. 2 and FIG. 3 show a further exemplary embodiment of a spindle drive 10, with which support elements 62 include a thread 78 that interacts with a corresponding counter-thread 79 on support tube 14. Support elements 62 are inserted in axial direction 76 onto or into support tube 14 until fastening device 54 bears axially against support elements 62. As shown in the cross-sectional view in FIG. 3 (along III-III in FIG. 2), an outer thread 79 and an inner thread 79 are formed on support tube 14, onto which support elements 62 may be easily screwed on or off. Support element 62, which bears against inner wall 70, is designed as inner ring 65, through which, e.g., a plunger spindle 16 passes. When attaching support element 62 using a thread 78, force 80 is introduced into support tube 14 via threads 78, 79 around the entire circumference of support tube 14, thereby preventing a partial increase in tension in the region of receptacle 52, and utilizing previously unloaded regions of support tube 14.

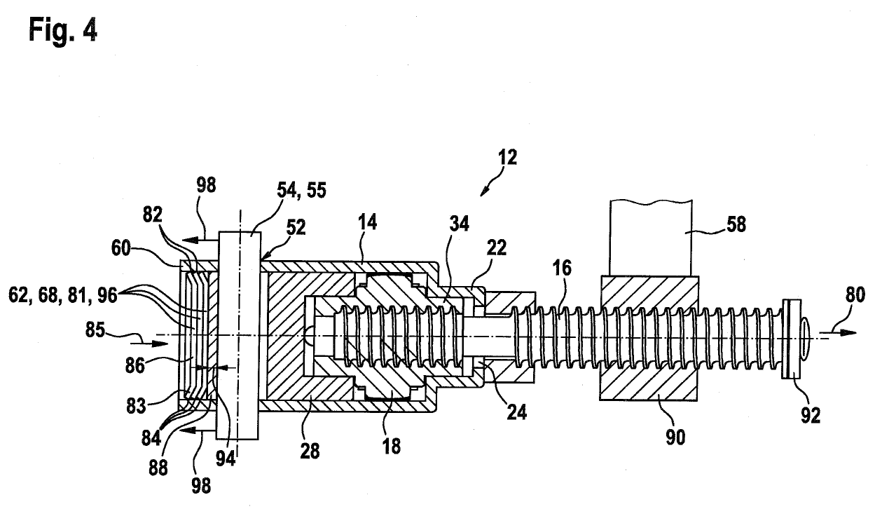

In a further variant, support elements 62 include self-cutting threads 78, which form counter-threads 79 in support tube 14 when they are turned in support tube 14. In this example, fastening device 54 bears axially against end plate 28, so that compression forces that act on spindle 16 are also absorbed via fastening bolt 54. In this design, end plate 28 has a constant outer diameter along its entire axial length 29, thereby increasing its mechanical stability. To transmit torque, recess 50 in support tube 14 is rectangular in shape, so that worm 39 may mesh with drive wheel 18. Only separate assembly 12 is shown in FIGS. 2 and 3; it may be installed completely independently of drive assembly 42. Coupling device 44 is then installed on preassembled assembly 12 via recess 46. Coupling device 44 fixes drive assembly 42 in position relative to support tube 14, to transfer torque. Support elements 62 may be installed, e.g, at the end of the installation of separate assembly 12, or once transmission drive unit 10 has been fully assembled. When support part 62 is designed as an outer ring 64, it may be installed on support tube 14 before spindle 16 is inserted into support tube 14. A further exemplary embodiment is shown in FIG. 4, with which support elements 62 are designed as clamping disks 81. Support elements 62 are designed as circular disks 68, which point away from fastening device 54 in the axial direction on a radially outer edge region 83. As a result, support elements 62 are plate-shaped in design, with a flat central region 86 and an angled, outer edge region 83. On its outer circumference 82, support element 62 includes an edge 84, which, in the installed state, is dug into inner wall 70 of support tube 14. Edge 84 may have an angle of, e.g., 90°, or it may have a sharp edge, e.g., with a burr. In FIG. 4, three clamping disks 81, for example, are installed in support tube 14 such that they bear axially against each other. Each clamping disk 81 digs into support tube 14 with its edge 84. A force-transmission disk 88 is located between support elements 62 and fastening device 54, which is more stable in design than support elements 62. Force-transmission disk 88 has, e.g., a greater thickness 94, or it is made of a stronger material. As a result, the force that is transferred in a straight line from pivot bolt 55 to force-transmission disk 88 is forwarded across a large surface area to circular supporting elements 62. It is thereby ensured that acting axial force 80 is forwarded evenly to entire circumference 82 of support elements 62. Force-transmission disk 88 is not attached radially to support tube 14, for instance, but is inserted loosely into support tube 14. When clamping disks 81 are installed axially, they are pressed against force-transmission disk 88, which, in turn, are pressed against fastening device 54. Central planar region 86 of clamping disks 81 therefore bears against fastening device 54, the preload being specified via the press-in force of clamping disks 81.

A spindle nut 90 is located on spindle 16, which is connected with a part 58 to be adjusted, e.g., a vehicle seat. When a crash occurs, a tension force 80 acts on spindle 16 via part 58 to be adjusted, thereby resulting in strong forces being produced between support tube 14 and fastening device 54. To prevent, e.g., fastening bolt 54 from tearing out, force 98 of fastening bolt 55 is transferred around circumference 82 of support elements 62 to end 60 of support tube 14.

It should be noted that, with regard for the exemplary embodiments presented in the figures and the description, many different combinations of the individual features are possible. For example, support tube 14 may be manufactured using different methods, and it may have different specific designs. Instead of being designed as an integrally formed, pot-shaped bearing receptacle 22, support tube 14 may also be designed as a smooth cylindrical tube in which two separate end shields 28 for supporting spindle 16 are located. Spindle 16 is preferably supported via drive wheel 18 supported thereon, although, in one variation, it may also be supported via bearing surfaces that are integrally formed directly on spindle 16. Likewise, the invention is not limited to the use of a pivot bolt 55 as fastening device 54. Instead, support tube 14 may also include another type of receptacle 52 for attachment to body/adjustable part 58. For example, a plunger spindle 16 may also be supported in support tube 14. Both pot-shaped bearing receptacles 22 then include an opening 24, through which spindle 16 extends. The device used to transfer torque is not limited to a worm gear pair 19, 39. Torque may also be transferred, e.g., using a spur gear. The shape and material used for support elements 62 is selected depending on the strength requirement. One or more support elements 62 may be attached, as necessary. The cross section of support tube 14 is not limited to a circle. When support tube 14 is cylindrical in design, support element 62 may simply be designed as a subsequently added base surface or wall reinforcement.

What is claimed is:

1. A transmission drive unit (10), in particular for adjusting a movable part (58) in a motor vehicle, with a drive assembly (42), which drives—via a driven element (40)—a drive wheel (18) supported on a spindle (16), the drive wheel (18) being rotatably supported in a support tube (14) that includes a receptacle for a fastening device (54) for diverting crash forces; at least one circular or annular support element (62) that can be installed subsequently and separately is attachable between an axial end (60) of the support tube (14) and the receptacle (52) in order to mechanically reinforce the support tube (14).

2. The transmission drive unit (10) as recited in claim 1,
wherein
the support element (62) is designed as an outer ring (64) that bears against an outer circumferential surface (66) of the support tube (14).

3. The transmission drive unit (10) as recited in claim 1,
wherein
the support element (62) is designed as an inner ring (65) or a circular disk (68) that bear against an inner wall surface (70) of the support tube (14).

4. The transmission drive unit (10) as recited in claim 1,
wherein
the support element (62) is connectable with the support tube (14) using a thread (78), which is self-tapping, in particular.

5. The transmission drive unit (10) as recited in claim 1,
wherein
the support element (62) is connectable with the support tube (14) via welding, bonding, or plastic material deformation.

6. The transmission drive unit (10) as recited in claim 1,
wherein
the material of the support element (62)—which is preferably hardened steel—has a higher strength than the material of which the support tube (14) is made, which is manufactured as a metallic deep-drawn part in particular.

7. The transmission drive unit (10) as recited in claim 1,
wherein
the receptacle (52) is designed as a radial through-bore in the support tube (14), into which a fastening bolt (55)—as the fastening element (54)—is slidable, and which is fixable in position on the body or the part (58) to be adjusted.

8. The transmission drive unit (10) as recited in claim 1,
wherein,
once the fastening element (54, 55) is installed, it bears axially against the support element (62).

9. The transmission drive unit (10) as recited in claim 1,
wherein
the drive wheel (18) is supported radially and axially in the support tube (14) via at least one end plate (28) with a pot-shaped bearing receptacle (22), the end plate (28) being made preferably of plastic.

10. The transmission drive unit (10) as recited in claim 1,
wherein
the drive assembly (42) is connected via a coupling device (44) with the support tube (44), which includes a radial recess (46) that enables the driven element (40) to engage in the drive wheel (18).

11. The transmission drive unit (10) as recited in claim 1,
wherein
the support element (62) is clamped tightly against the fastening device (54), which is clamped on the support tube (14).

12. The transmission drive unit (10) as recited in claim 1,
wherein
the support element (62) is designed as a clamping disk (81) that engages in the inner wall surface (70) of the support tube (14) around its entire circumference (82) via an edge (84).

13. The transmission drive unit (10) as recited in claim 1,
wherein
the clamping disk (81) has an outer edge region (83), which points axially away from the fastening device (54), the clamping disk (81) being manufactured, in particular, as a bent blank (96).

14. The transmission drive unit (10) as recited in claim 1,
wherein
several identical support elements (62, 81) are attached to the support tube (14) such that they bear against each other axially.

15. The transmission drive unit (10) as recited in claim 1,
wherein
a force-transmission disk (88) is located between the at least one support element (62) and the fastening device (54), which transfers forces (98) from the fastening device (54) to the at least one support element (62).

16. A method for manufacturing a transmission drive unit (10) as recited in claim 1,
wherein
the spindle (16) with the drive wheel (18) and the support element (62) are installed on the support tube (14) as a separate component (12), then the drive assembly (42) is attached to the support tube (14) using the coupling device (44).

17. The method as recited in claim 16,
wherein
a standard support tube (14) is always used for various strength requirements of transmission drive unit (10), to which support elements (62) having different stabilities—depending on the load to be placed on the support tube (14)—or a different number of identical support elements (62) of a modular system are attached.

18. The method as recited in claim 17,
wherein
the support element (62) is slid into the support tube (14) and is pressed against the fastening element (54) with preload, the support element (62) being automatically secured against displacement opposite to the insertion direction (85) by its digging into the support tube (14).
